(19) United States
(12) Patent Application Publication
(10) Pub. No.: US 2024/0016119 A1
(43) Pub. Date: Jan. 18, 2024

(54) HORSE MANE BANDING APPARATUS AND METHOD

(71) Applicants: James Vernon Henrekin, Deer Grove, IL (US); Sandra Jean Henrekin, Deer Grove, IL (US); Timothy Mark Johnson, Sterling, IL (US)

(72) Inventors: James Vernon Henrekin, Deer Grove, IL (US); Sandra Jean Henrekin, Deer Grove, IL (US); Timothy Mark Johnson, Sterling, IL (US)

(21) Appl. No.: 18/199,919

(22) Filed: May 20, 2023

Related U.S. Application Data
(60) Provisional application No. 63/364,992, filed on May 19, 2022.

(51) Int. Cl. A01K 13/00; A45D 8/00

(52) U.S. Cl. CPC A01K 13/00; A45D 8/001; A45D 8/002

(57) ABSTRACT

An apparatus for banding hair comprises a magazine configured to hold elastic bands and to urge at least one of the elastic bands along a first axis. The magazine defines an ejection port configured to pass the at least one of the elastic bands therethrough. The apparatus further comprises an ejection assembly arranged and configured to urge the at least one of the elastic bands through the ejection port. The apparatus further comprises a guide arranged and configured to hold the hair in a banding orientation such that the hair extends from the guide both adjacently to the ejection port and off-center from the first axis.

### CROSS REFERENCE TO RELATED APPLICATION(S)

This application claims the benefit of priority to U.S. Provisional Patent Application No. 63/364,992, filed on May 19, 2022, the disclosure of which is incorporated herein by reference.

### FIELD OF THE INVENTION

The present disclosure relates to horse grooming and, more particularly, to apparatuses and methods for banding a horse's mane.

### BACKGROUND

Historically, banding a horse's mane has involved extending and tightening rubber bands around locks of the horse's mane, for styling the mane into ponytail-like or pigtail-like tresses and/or into rolls, balls, knobs, lattices or other hair designs comprising such tresses.

Historical approaches to banding horses' manes have been undesirably laborious.

### SUMMARY OF THE INVENTION

One or more embodiments provide and apparatus for banding hair. The apparatus comprises a magazine configured to hold elastic bands and to urge at least one of the elastic bands along a first axis. The magazine defines an ejection port configured to pass the at least one of the elastic bands therethrough. The apparatus further comprises an ejection assembly arranged and configured to urge the at least one of the elastic bands through the ejection port. The apparatus further comprises a guide arranged and configured to hold the hair in a banding orientation such that the hair extends from the guide both adjacently to the ejection port and off-center from the first axis.

One or more embodiments provide a method for banding hair. The method comprises concurrently holding each one of a plurality of elastic bands in an elastically deformed, generally C-shaped, open state. The method further comprises extending at least one of the elastic bands around the hair when the at least one of the elastic bands is not in an elastically deformed, at least generally closed ring state. The at least one of the elastic bands transitions itself to the elastically deformed, at least generally closed ring state when the at least one of the elastic bands is extended around the hair.

It will be appreciated that the various embodiments described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

Some of the figures shown herein may include dimensions. Further, the figures shown herein may have been created from scaled drawings, scaled models, or from photographs that are scalable. It is understood that such dimensions, or the relative scaling within a figure, are by way of example, and not to be construed as limiting unless so stated in a claim. Persons of ordinary skill will also recognize that computer-aided design (“CAD”) renderings may include lines that pertain to changes in surface geometry, and not necessarily to component features.

FIG. 1 illustrates a front plan view of a horse head and neck having a mane including a lock to be banded, and a left side plan view of a hair banding tool in accordance with aspects of the present disclosure.

FIG. 2 illustrates an exploded rear sectional view of the hair banding tool of FIG. 1, relative to line/plane 2-2 of FIG. 6A.

FIG. 3 illustrates an assembled rear sectional view of the hair banding tool of FIG. 1, relative to line/plane 2-2 of FIG. 6A.

FIG. 4A illustrates a top plan view of a hair band in a not elastically deformed, at least generally closed ring state in accordance with aspects of the present disclosure.

FIG. 4B illustrates a top plan view of the hair band of FIG. 4 in an elastically deformed, at least generally closed ring state in accordance with aspects of the present disclosure.

FIG. 4C illustrates a top plan view of the hair band of FIG. 4 in an elastically deformed, generally C-shaped, open state in accordance with aspects of the present disclosure.

FIG. 4D illustrates a backside plan view of the hair band of FIG. 4 in an elastically deformed, fully unfurled, generally I-shaped state in accordance with aspects of the present disclosure.

FIG. 5 illustrates a backside plan view of an alternative, notched hair band in an elastically deformed, generally C-shaped, open state in accordance with aspects of the present disclosure.

FIG. 6A illustrates a top plan view of the hair banding tool of FIG. 1 with the funnel empty and the jaws of the funnel closed.

FIG. 6B illustrates a top plan view of the hair banding tool of FIG. 1 with the jaws of the funnel splayed apart from each other.

FIG. 6C illustrates a top plan view of the hair banding tool of FIG. 1 with the jaws of the funnel closed around a lock of hair.

FIGS. 7A-7C illustrate side plan views of hair band ejection control features of the hair banding tool of FIG. 1.

FIGS. 8A-8C illustrate side plan views of alternative hair band ejection control features in an alternative hair banding tool in accordance with aspects of the present disclosure

### ELEMENT NUMBERING

Following is(are) one or more lists of element numbers, including at least one noun used to describe each listed element. It should be understood that none of the embodiments disclosed herein are limited to these nouns, and these descriptors can further include other words that would be understood by a person of ordinary skill reading and reviewing this disclosure in its entirety.

| | |
|---|---|
| 100 | horse, horse head, horse neck, |
| | head, neck, horse head and |
| | neck, horse bust |
| 120 | horse mane, mane, horse's |
| | mane |
| 140 | lock, hair, hair group, mane |
| | portion, hair bundle, group of |
| | hairs, bundle of hairs, lock of |
| | hair, hair lock, lock |
| 160 | hair banding tool, horse mane |
| | banding tool, banding tool, tool, |
| | hand tool, mane tool, hair tool |
| 180 | funnel, scoop, hair funnel, |
| | tapered funnel |
| 200 | tapered funnel end, relatively |
| | smaller funnel end, tapered end, |
| | relatively smaller end, smaller |
| | end, small end, bottom end |
| 220 | flared funnel end, relatively |
| | larger funnel end, flared end, |
| | relatively larger end, larger end, |
| | large end, top end |
| 240 | band magazine, magazine, clip, |
| | band holder, dispenser, band |
| | dispenser, spring-loaded |
| | magazine, band supply |
| | chamber, band chamber, |
| | chamber |
| 260 | magazine top end, top end, top, |
| | end |
| 280 | magazine bottom end, bottom |
| | dispensing end, ejection end, |
| | bottom end, end |
| 300 | magazine front face, front face |
| 320 | magazine back face, back face |
| 340 | left jaw, left jaw member, left |
| | funnel member, jaw member, |
| | jaw(s) |
| 360 | right jaw, right jaw member, |
| | right funnel member, jaw |
| | member, jaw(s) |
| 380 | handle, grip, hand grip, grip |
| 400 | handle top surface, handle grip |
| | top surface, grip top surface, |
| | top surface |
| 420 | handle back surface, handle grip |
| | back surface, grip back surface, |
| | back surface |
| 440 | handle bottom surface, handle |
| | grip bottom surface, grip bottom |
| | surface, bottom surface |
| 460 | handle left side, handle grip left |
| | side, grip left side, left side |
| 480 | handle right side, handle grip |
| | right side, grip right side, right |
| | side |
| 500 | thumb switch, funnel control |
| | switch, funnel actuator switch, |
| | thumb-actuatable switch, switch |
| 520 | finger holes, handgrip holes, |
| | hand holes, plurality of finger |
| | holes |
| 540 | index-finger-actuatable switch, |
| | index-finger-actuatable trigger |
| | switch, index-finger-actuatable |
| | ejection trigger switch, index |
| | finger switch, trigger switch, |
| | trigger, switch, index-finger- |
| | actuatable trigger, finger switch |
| 560 | magazine housing, magazine |
| | cover, shell, case, magazine |
| | case, housing, cover |
| 580 | holding space, housing space, |
| | magazine space, magazine |
| | holding space, magazine |
| | housing space, space |
| 600 | cylindrical hair band guide |
| | sleeve, hair band guide sleeve, |
| | band guide sleeve, guide |
| | sleeve, magazine sleeve, |
| | sleeve, magazine guide, |
| | magazine guide sleeve, internal |
| | guide sleeve |
| 620 | central axial bore, axial bore, |
| | bore, through-hole, guide bore, |
| | magazine guide bore, magazine |
| | axial bore |
| 640 | first hair band, hair band, band, |
| | first fastener, first hair fastener, |
| | fastener, hair fastener, clamp, |
| | hair clamp, first clamp, first hair |
| | clamp, first elastic band, elastic |
| | band |
| 660 | second hair band, hair band, |
| | band, second fastener, second |
| | hair fastener, fastener, hair |
| | fastener, clamp, hair clamp, |
| | second clamp, second hair |
| | clamp, second elastic band, |
| | elastic band |
| 680 | plurality of additional hair |
| | bands, additional hair bands, |
| | hair bands, additional fasteners, |
| | additional hair fasteners, |
| | fasteners, hair fasteners, |
| | clamps, hair clamps, additional |
| | clamps, additional hair clamps, |
| | plurality of elastic bands, elastic |
| | bands, plurality of hair bands |
| 700 | last hair band, hair band, last |
| | band, last fastener, last hair |
| | fastener, fastener, hair fastener, |
| | clamp, hair clamp, last clamp, |
| | second hair clamp, last elastic |
| | band, elastic band |
| 720 | magazine lid, lid, top, magazine |
| | top, cap, magazine cap, |
| | removable top of magazine |
| 740 | magazine spring alignment rod, |
| | spring alignment rod, alignment |
| | rod, rod, piston rod, magazine |
| | piston rod |
| 760 | biasing collar, collar, piston |
| | head, head, magazine piston |
| | head, head member |
| 780 | magazine spring, spring, coil, |
| | spring coil, coiled spring |
| 800 | pass-through space, through- |
| | hole, hole, hair receiving hole, |
| | receiving hole, band hole |
| 820 | opposing tapered ends, |
| | opposing ends, tapered ends, |
| | ends |
| 840 | body portion, portion, body, |
| | band body, band body portion |
| 860 | notched hair band, band, |
| | notched fastener, notched hair |
| | fastener, fastener, hair fastener, |
| | notched clamp, notched hair |
| | clamp, notched elastic band, |
| | elastic band, notched band |
| 880 | opposing notches, notches, |
| | grooves, opposing grooves, |
| | indents, opposing indents |
| 900 | top back surface, top surface, |
| | surface, upper surface, upper |
| | back surface |
| 920 | bottom back surface, bottom |
| | surface, surface, lower surface, |
| | lower back surface |
| 930 | lateral split line/plane, lateral |
| | split line, lateral split plane, split |
| | line/plane, split line, split plane, |
| | line, plane, plane line |
| 940 | passageway, hair lock |
| | passageway, hair passageway, |
| | funnel passageway, through- |
| | channel, channel, hair channel, |
| | lock channel, hair lock channel |
| 960 | hair band ejection control |
| | features, band ejection control |
| | features, ejection control |
| | features, hair band dispensing |
| | control features, band |
| | dispensing control features, |
| | dispensing control features, hair |
| | band ejection control |
| | mechanics, band ejection |
| | control mechanics, ejection |
| | control mechanics, mechanics, |
| | controls, features |
| 980 | ejection port, port, ejection site, |
| | muzzle opening, ejection |
| | opening, opening, ejection |
| | portal, portal, ejection |
| | passageway, passageway |
| 1000 | ejection slide, slide, ejection |
| | shoot, shoot, magazine shoot, |
| | magazine slide |
| 1020 | latch pin, latch, pin, retaining |
| | pin, control pin, trigger pin, |
| | release pin, release |
| 1040 | lower edge, edge, bottom edge, |
| | bottom edge, bottom rim |
| 1060 | direction, direction line, path |
| 1080 | longitudinal axis, longitude, |
| | axis, longitude line, axis line, |
| | line |
| 1100 | angle, separation, angular |
| | separation, angular |
| | displacement |
| 1200 | alternative hair band ejection |
| | control features, hair band |
| | ejection control features, band |
| | ejection control features, |
| | ejection control features |
| 1220 | cog wheel, cog, wheel |
| 1240 | first linear actuator, linear |
| | actuator, first actuator |
| 1260 | second linear actuator, linear |
| | actuator, second actuator |

### Detailed Description of One or More Embodiments

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates. At least one embodiment of the present invention will be described and shown, and this application may show and/or describe other embodiments of the present invention, and further permits the reasonable and logical inference of still other embodiments as would be understood by persons of ordinary skill in the art. Unless expressly described or claimed herein as particularly limited to one or more specific materials, any component of the invention may be made from any one or more suitable metals, plastics, woods, fabrics, fibers, and/or combination(s) thereof (and/or any other suitable material(s) or combination(s) thereof) as would be understood by one of ordinary skill in the art.

It is understood that any reference to “the invention” is a reference to an embodiment of a family of inventions, with no single embodiment including an apparatus, process, or composition that should be included in all embodiments, unless otherwise stated. Further, although there may be discussion with regards to “advantages” provided by some embodiments of the present invention, it is understood that yet other embodiments may not include those same advantages, or may include yet different advantages. Any advantages described herein are not to be construed as limiting to any of the claims. The usage of words indicating preference, such as “various embodiments” or “preferably,” refers to features and aspects that are present in at least one embodiment, but which are optional for some embodiments, it therefore being understood that use of the word “preferably” implies the term “optional.”

Like reference numerals refer to like parts throughout the description and the drawings. Additionally, the use of an N-series prefix for an element number (NXX.XX) refers to an element that is the same as the non-prefixed element (XX.XX) except as shown and described. As an example, an element 1020.1 would be the same as element 20.1, except for those different features of element 1020.1 shown and described. Further, common elements and common features of related elements may be drawn in the same manner in different figures, and/or use the same symbology in different figures. As such, it is not necessary to describe the features of 1020.1 and 20.1 that are the same, since these common features are apparent to a person of ordinary skill in the related field of technology. Further, it is understood that some features 1020.1 and 20.1 may be backward compatible, such that a feature of a later discussed embodiment (NXX.XX) may include features compatible with other various embodiments that were discussed earlier (MXX.XX), as would be understood by those of ordinary skill in the art. This description convention also applies to the use of prime (′), double prime (″), triple prime (′″) and star or asterisk (*) suffixed element numbers. Therefore, it is not necessary to describe the features of 20.1, 20.1′, 20.1″, 20.1″ and 20* that are the same, since these common features are apparent to persons of ordinary skill in the related field of technology.

What follows are paragraphs that express particular embodiments of the present invention. In those paragraphs that follow, some element numbers are prefixed with an “X” indicating that the words pertain to any of the similar features shown in the drawings or described in the text. However, those of ordinary skill in the art will recognize various other non-X prefixed element numbers that discuss features applicable to other embodiments.

This document may use different words to describe the same element number, or to refer to an element number in a specific family of features (NXX.XX). It is understood that such multiple, different words are not intended to provide a redefinition of any language herein. It is understood that such words demonstrate that the particular feature can be considered in various linguistical ways, such ways not necessarily being additive or exclusive.

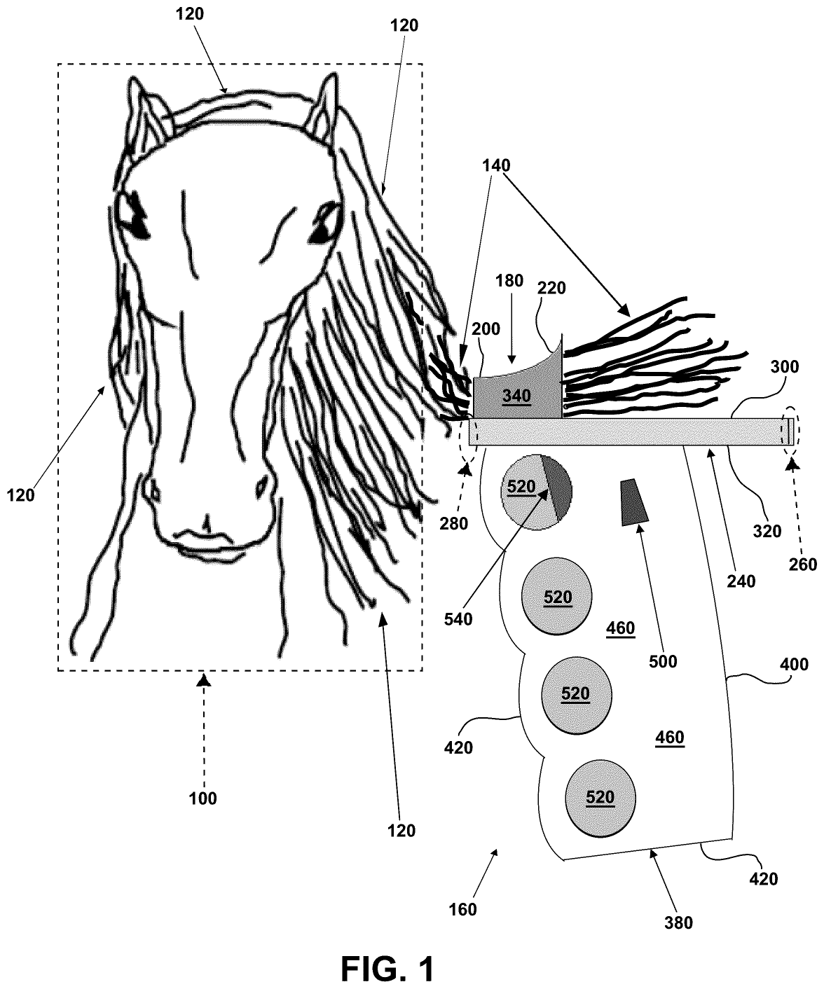

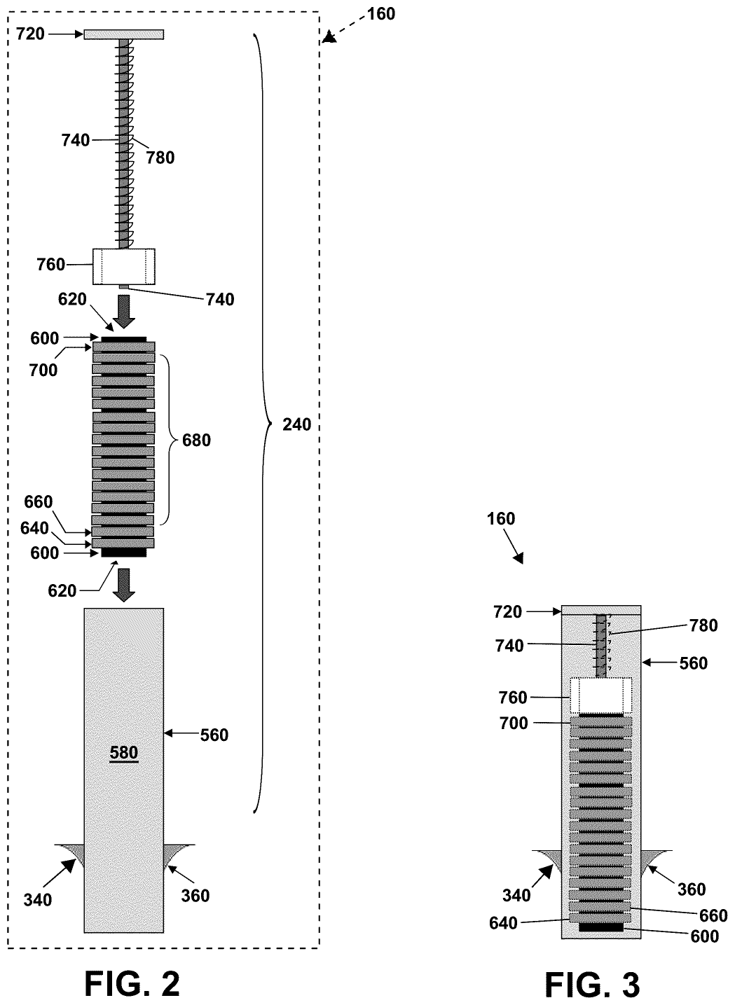

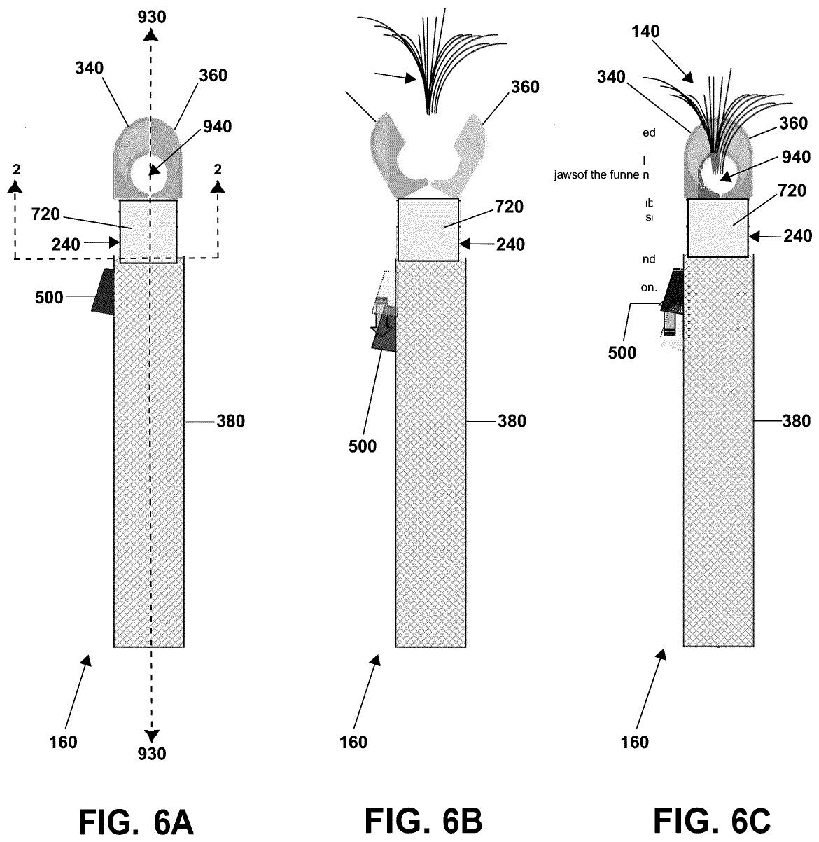

FIG. 1 illustrates a front plan view of a horse head and neck (i.e., a “horse bust”) 100 having a mane 120 including a lock 140 to be banded, and a left side plan view of a hair banding tool 160 in accordance with aspects of the present disclosure. The hair banding tool 160 comprises a funnel 180. The funnel 180 is adapted and configured to receive, hold, and orient the lock of hair 140. The funnel 180 comprises a relatively smaller end 200 and a relatively larger end 220. The hair banding tool 160 further comprises a spring-loaded magazine 240. The magazine 240 has a top end 260, a bottom end 280, a front face 300, and a back face 320. The funnel 180 is coupled to the front face 300 of the magazine 240 (relatively closer to the bottom end 280 of the magazine 240 and relatively farther away from the top end 260 of the magazine 240). The funnel 180 comprises a left jaw member 340 and a right jaw member 360 (the right jaw member 360 is not expressly illustrated in FIG. 1, but see, e.g., FIG. 2 and FIGS. 6A-6C).

The banding tool 160 further comprises a handle 380. The handle 380 is coupled to the back face 320 of the magazine 240. The handle 380 has a top surface 400, a back surface 420, a bottom surface 440, a left side 460, and a right side 480 (the right side 480 is not expressly illustrated in FIG. 1, but see, e.g., FIGS. 6A-6C). The handle 380 comprises a thumb-actuatable switch 500 extending from the left side 460 of the handle 380. The thumb-actuatable switch 500 is suitably mechanically coupled to the funnel 180 to control operations of the jaw members 340 and 360 (which are discussed further below). Further, the handle 380 defines a plurality of finger holes 520, and comprises an index-finger-actuatable switch 540 partially extending into one of the finger holes 520 that is closer to the back face 320 of the magazine 240 than the other ones of the finger holes 520. The index-finger-actuatable switch 540 is suitably mechanically coupled to the magazine 240 to control hair band ejection/dispensing operations (which are discussed further below).

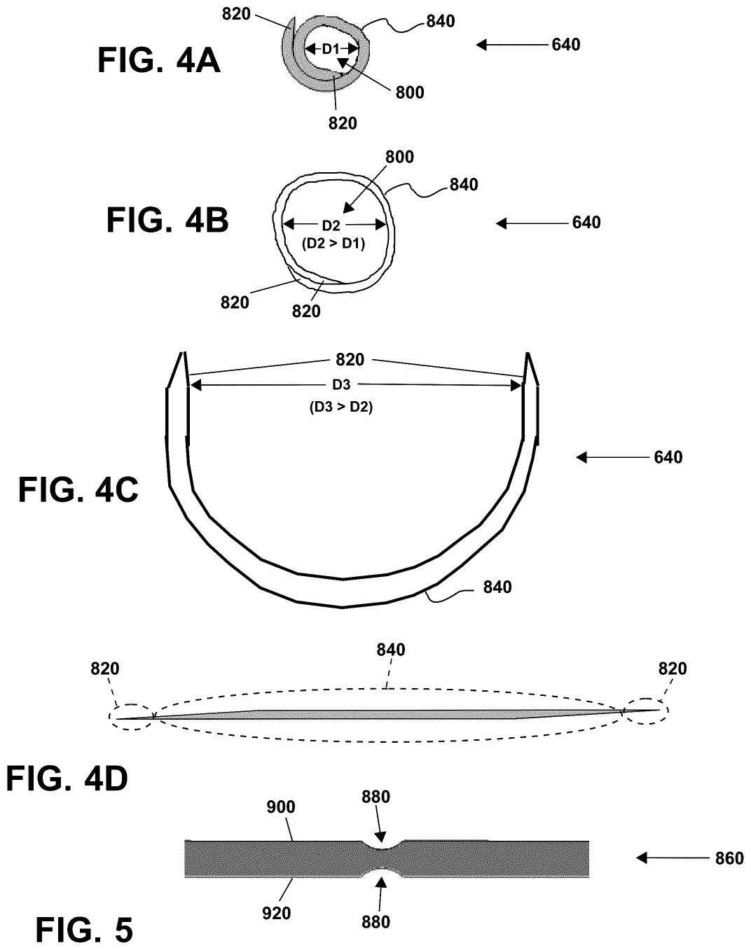

FIG. 2 and FIG. 3 illustrate an exploded rear sectional view and an assembled rear sectional view, respectively, of the hair banding tool 160, relative to line/plane 2-2 of FIG. 6A. The spring-loaded magazine 240 comprises a magazine housing 560. The housing 560 provides a holding space 580. The magazine 240 further comprises a cylindrical hair band guide sleeve 600 having a central axial bore 620 extending therethrough. The magazine 240 further comprises a first hair band 640 slidably loaded onto the guide sleeve 600, a second hair band 660 slidably loaded onto the guide sleeve 600 and axially aligned with and abutting the first hair band 640, a plurality of additional hair bands 680 slidably loaded onto the guide sleeve 600, abutting each other, and axially aligned with the first hair band 640 and second hair band 660, a last hair band 700 slidably loaded onto the guide sleeve 600 and axially aligned with and abutting the plurality of additional hair bands 680, a magazine lid 720 removably coupled to the housing 560 at the top end 260 of the magazine 240, a magazine spring alignment rod 740 extending from the lid 720 toward the bottom end 280 of the magazine 240 and into the bore 620, a biasing collar 760 slidable on the rod 740 and abutting the last hair band 700, and a magazine spring 780 coiled around the rod 740 and coupling the lid 720 to the collar 760. The first hair band 640, the second hair band 660, the additional hair bands 680, and the last hair band 700 are configured as identically to each other as practicable. Each of the first hair band 640, the second hair band 660, the additional hair bands 680, and the last hair band 700 is suitably elastic, resilient, and otherwise configured to be expandable from a not elastically deformed, at least generally closed ring state (see, e.g., FIG. 4A) through an elastically deformed, at least generally closed ring state (see, e.g., FIG. 4B) to an elastically deformed, generally C-shaped, open state (see, e.g., FIG. 4C). And each of the first hair band 640, the second hair band 660, the additional hair bands 680, and the last hair band 700 is suitably elastic, resilient, and otherwise configured to transition itself from the elastically deformed, generally C-shaped, open state (see, e.g., FIG. 4C) at least back to the elastically deformed, at least generally closed ring state (see, e.g., FIG. 4B).

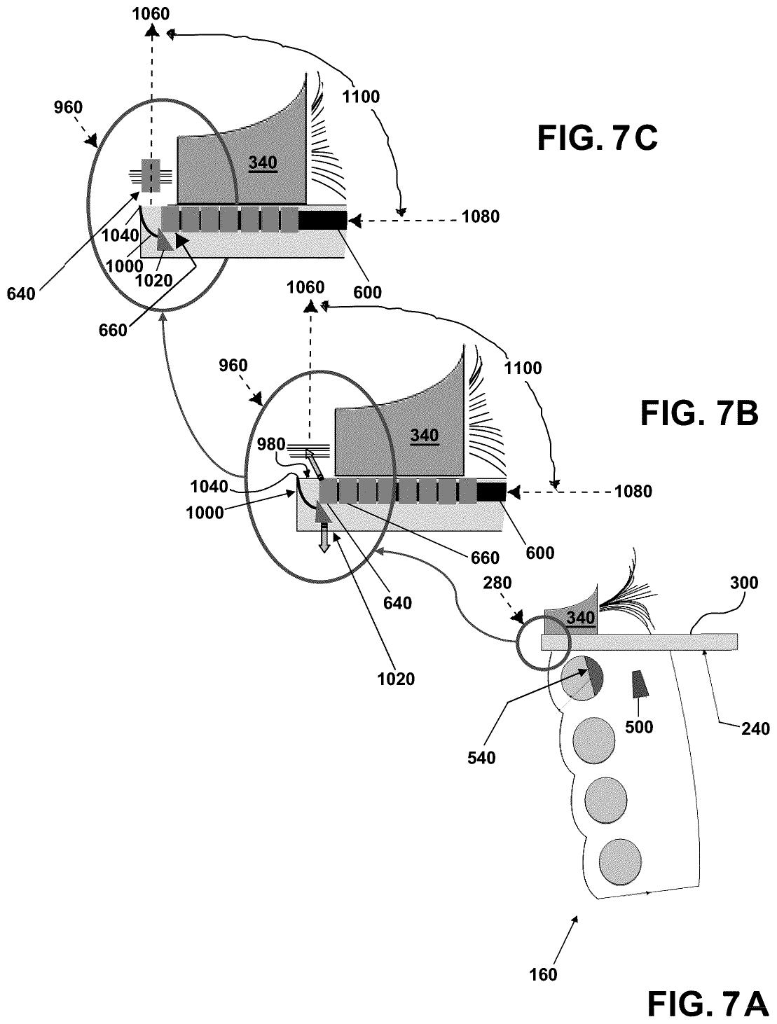

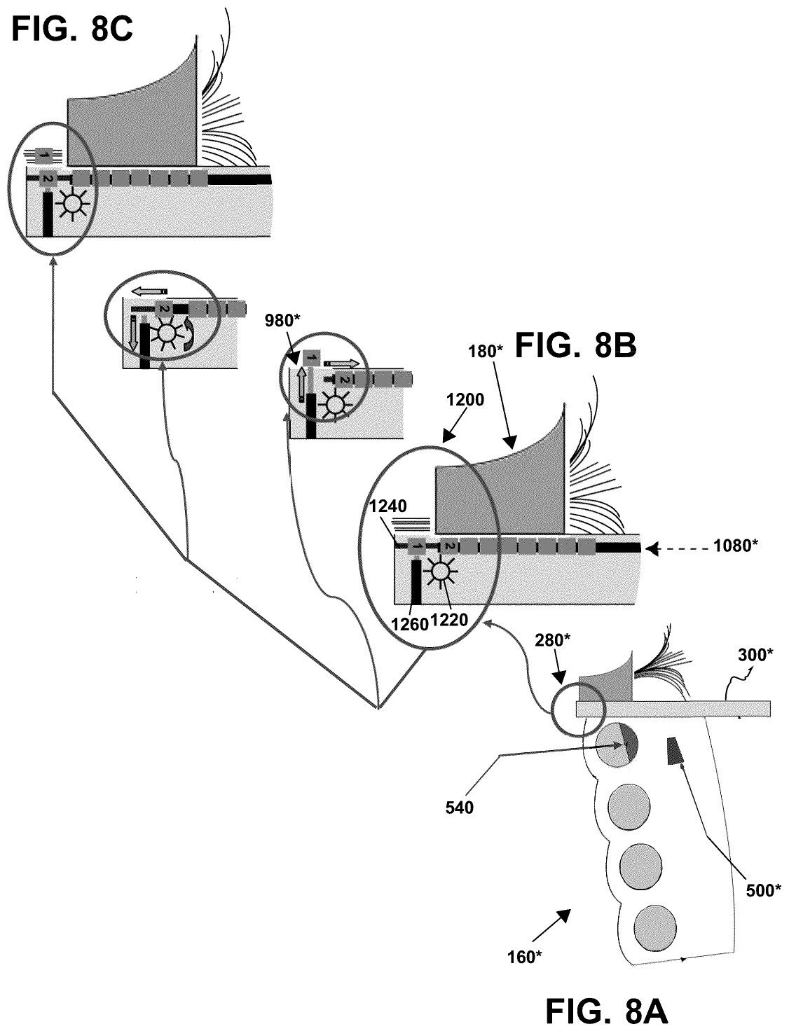

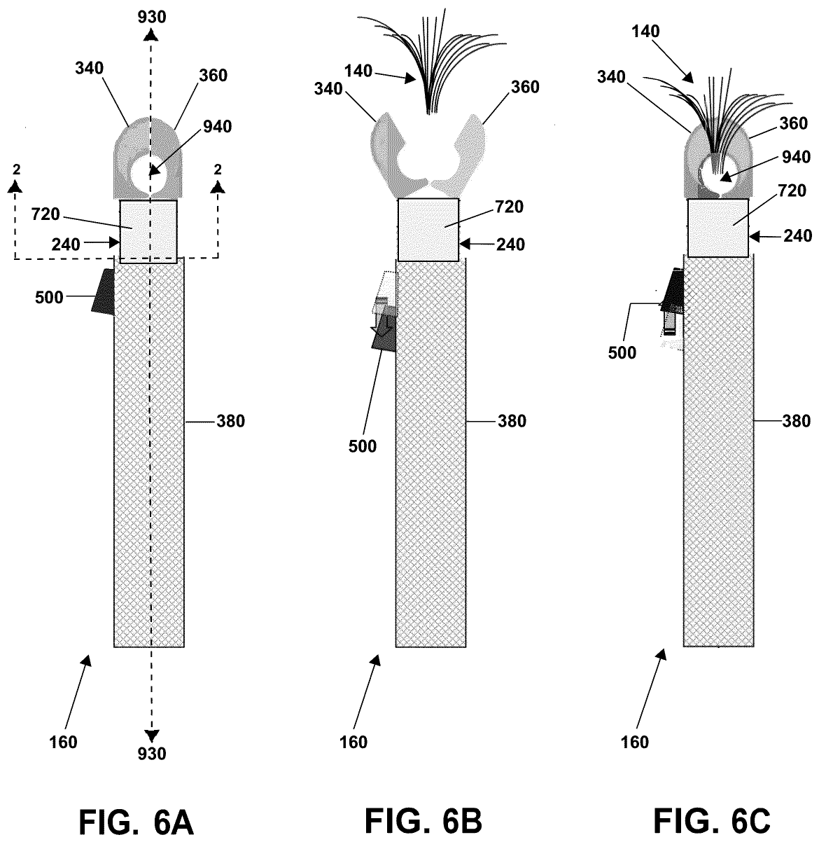

When the first hair band 640, the second hair band 660, the additional hair bands 680, and the last hair band 700 are loaded onto the guide sleeve 600, each of the first hair band 640, the second hair band 660, the additional hair bands 680, and the last hair band 700 is held (by the guide sleeve 600) in an elastically deformed, generally C-shaped, open state (see, e.g., FIG. 4C). Thus, it should be appreciated that loading the first hair band 640, the second hair band 660, the additional hair bands 680, and the last hair band 700 onto the onto the guide sleeve 600 includes expanding each of the first hair band 640, the second hair band 660, the additional hair bands 680, and the last hair band 700 from a not elastically deformed, at least generally closed ring state (see, e.g., FIG. 4A) through an elastically deformed, at least generally closed ring state (see, e.g., FIG. 4B) to an elastically deformed, generally C-shaped, open state (see, e.g., FIG. 4C). Further, when the hair banding tool 160 is assembled (see, e.g., FIG. 3), the spring 780 is compressed and, consequently, tends to force the collar 760 away from the lid 720 (and, thus, away from the top of the top end 260 of the magazine 240) into abutment with the last hair band 700 and toward the bottom end 280 of the magazine 240, which, in turn, tends to force the last hair band 700 toward the bottom end 280 of the magazine 240, which, in turn, which, in turn, tends to force the plurality of additional hair bands 680 toward the bottom end 280 of the magazine 240, which, in turn, tends to force the second hair band 660 toward the bottom end 280 of the magazine 240, which, in turn, tends to force the first hair band 640 toward the bottom end 280 of the magazine 240. Complementary hair band ejection control features are discussed below (e.g., in connection with FIGS. 7A-7C and 8A-8C).

FIG. 4A illustrates a top plan view of the first hair band 640 in a not elastically deformed, at least generally closed ring state in accordance with aspects of the present disclosure. In the not elastically deformed, at least generally closed ring state, the hair band 640 is not elastically deformed, and is generally annular, somewhat spirally overlapping, and bounds a pass-through space or through-hole 800 having a maximum diameter-like dimension, D1. Further, the hair band 640 comprises a pair of opposing tapered ends 820 and a body portion 840 extending between the tapered ends 820. The tapered ends 820 are suitably configured to facilitate overlapping with each other and/or overlapping with the body portion 840 as the hair band 640 recoils itself from an elastically deformed, generally C-shaped, open state (see also, e.g., FIG. 4C) and/or from an elastically deformed, at least generally closed ring state (see also, e.g., FIG. 4B). As noted above, e.g., in connection with FIGS. 2 and 3, the first hair band 640, the second hair band 660, the additional hair bands 680, and the last hair band 700 are configured as identically to each other as practicable. Accordingly, it should be appreciated that the size, shape, elasticity, resilience, and other characteristics of the second hair band 660, the additional hair bands 680, and the last hair band 700 are all practicably identical to those of the first hair band 640.

FIG. 4B illustrates a top plan view of the first hair band 640 in an elastically deformed, at least generally closed ring state in accordance with aspects of the present disclosure. In the elastically deformed, at least generally closed ring state, the hair band 640 has been elastically deformed but is still generally annular and somewhat spirally overlapping (although less overlapping than the not elastically deformed, at least generally closed ring state; compare FIGS. 4A and 4B). Further, in the elastically deformed, at least generally closed ring state, the hair band 640 bounds the through-hole 800 such that the through-hole 800 has a maximum diameter-like dimension, D2, which is greater than the maximum diameter-like dimension, D1, of the through-hole 800 in the not elastically deformed, at least generally closed ring state (again, compare FIGS. 4A and 4B).

FIG. 4C illustrates a top plan view of the first hair band 640 in an elastically deformed, generally C-shaped, open state in accordance with aspects of the present disclosure. In the elastically deformed, generally C-shaped, open state, the hair band 640 has been elastically deformed (even more than the elastically deformed, at least generally closed ring state; compare FIGS. 4B and 4C) to a point where the tapered ends 820 no longer overlap each other or any of the body portion 840 and the hair band 640 has become generally C-shaped (and not a generally closed ring). Further, in the elastically deformed, generally C-shaped, open state, the minimum distance, D3, between the tapered ends 820 is greater than the maximum diameter-like dimension, D2, of the through-hole 800 in the elastically deformed, at least generally closed ring state (compare FIGS. 4B and 4C). As noted above, e.g., in connection with FIGS. 2 and 3, when the first hair band 640, the second hair band 660, the additional hair bands 680, and the last hair band 700 are loaded onto the guide sleeve 600, each of the first hair band 640, the second hair band 660, the additional hair bands 680, and the last hair band 700 is held (by the guide sleeve 600) in the elastically deformed, generally C-shaped, open state.

FIG. 4D illustrates a backside plan view of the first hair band 640 in an elastically deformed, fully unfurled, generally I-shaped state in accordance with aspects of the present disclosure.

FIG. 5 illustrates a backside plan view of an alternative, notched hair band 860 in an elastically deformed, generally C-shaped, open state in accordance with aspects of the present disclosure. The notched hair band 860 is configured as identically to the first hair band 640 as practicable, except the notched hair band 860 has a pair of opposing notches 880 (one in its top back surface 900 and the other in its bottom back surface 920) that can facilitate handling of the notched hair band 860 by the spring-loaded magazine 240 (the magazine 240 is discussed above, e.g., in connection with FIGS. 2 and 3 and is further discussed below, e.g., in connection with FIGS. 7A-7C).

FIG. 6A illustrates a top plan view of the hair banding tool of 160 with the funnel 180 empty and the jaws 340, 360 of the funnel 180 closed together. The funnel 180 and the magazine 240 are each laterally symmetrical about a split line/plane 930. When the jaws 340, 360 are closed together, the funnel 180 provides a passageway 940 therethrough that is suitable for holding and orienting the lock of hair 140 (the lock 140 is not expressly illustrated in FIG. 6A, but see, e.g., FIGS. 1, 6B, 6C, 7A-7C, and 8A-8C). In FIG. 6A, the thumb-actuatable switch 500 is illustrated in its rest (not actuated) position. The left jaw 340 and the right jaw 360 are each suitably mechanically coupled to the magazine 240 and suitably mechanically coupled to the thumb-actuatable switch 500 such that actuation of the thumb-actuatable switch 500 causes jaws 340, 360 to splay apart or otherwise suitably open or separate from each other.

FIG. 6B illustrates a top plan view of the hair banding tool 160 with the jaws 340, 360 of the funnel 180 splayed apart from each other. FIG. 6C illustrates a top plan view of the hair banding tool 160 with the jaws 340, 360 closed around the lock of hair 140. It should be appreciated that splaying apart or otherwise suitably opening apart or spreading apart the jaws 340, 360 arranges the funnel 180 to readily receive the lock of hair 140 without having to (more laboriously) thread the lock 140 through the passageway 940. The thumb-actuatable switch 500 and the jaws 340, 360 are suitably spring loaded such that when the thumb-actuatable switch 500 is released the thumb-actuatable switch 500 automatically returns to its rest position and the jaws 340, 360 automatically close back together (see also, e.g., FIG. 6A).

FIGS. 7A-7C illustrate side plan views of hair band ejection control features 960 of the hair banding tool 160. The hair band ejection control features 960 are incorporated into the bottom end 280 of the magazine 240, and comprise an ejection port 980 in the magazine front face 300, an ejection slide 1000, and a latch pin 1020. The port 980 has a lower edge 1040, and the port 980 is suitably sized, shaped, and positioned to permit the first hair band 640 to pass through the port 980 as the hair band 640 exits the slide 1000. The slide 1000 curves upwardly from the lower edge 1040 of the port 980 to suitably slightly below the latch pin 1020 and suitably more rearward than the first hair band 640 (when the first hair band 640 is loaded onto the guide sleeve 600).

Additionally, the ejection port 980 and the ejection slide 1000 are suitably configured and arranged to guide the hair band 640 such that the hair band 640 exits the port 980 in a direction 1060 that is as close to coplanar to the lateral split line/plane 930 of the magazine 240 and the funnel 180 as practicable, and that is as close to transverse to the longitudinal axis 1080 of the guide sleeve 600 as practicable. Accordingly, an angle 1100 between the direction 1060 and the longitudinal axis 1080 in the split plane 930 (the split line/plane 930 is identified in 6A) is as close to 90 degrees as practicable. The latch pin 1020 is suitably spring loaded and mechanically coupled to the index-finger-actuatable switch 540 such that when the switch 540 is not actuated at least a portion of the latch pin 1020 is suitably interposed between (or suitably returns to interposition between, accordingly) the hair band 640 and the slide 1000, and such that actuation of the switch 540 causes the latch pin 1020 to withdraw from between the hair band 640 and the slide 1000.

FIGS. 8A-8C illustrate side plan views of alternative hair band ejection control features 1200 in an alternative hair banding tool 160* in accordance with aspects of the present disclosure. The hair band ejection control features 1200 are incorporated into a bottom end 280* of a magazine 240*, and comprise an ejection port 980* in a magazine front face 300*, a cog wheel 1220, a first linear actuator 1240, and a second linear actuator 1260. The first linear actuator 1240 is as closely aligned with a longitudinal axis 1080* of a guide sleeve 600* as practicable. The second linear actuator 1260 is as closely to coplanar to a lateral split line/plane 930* of the magazine 240* and a funnel 180* as practicable, and is aligned as closely to transverse to the longitudinal axis 1080* of the guide sleeve 600* as practicable.

The ejection control features 1200 are further suitably arranged, coupled, and configured such that:
(1) an actuation of an index-finger-actuatable switch 540*
   (a) causes the first linear actuator 1240 to retract upward and thereby free a first hair band 640* for ejection, and
   (b) causes the second linear actuator 1260 to extend and push the first hair band 640* through the ejection port 980* (and, thus, push the first hair band 640* out of the magazine 240*); and
(2) a release of the index-finger-actuatable switch 540*
   (a) causes the first linear actuator 1240 to extend downward,
   (b) causes the cog wheel 1220 to suitably synchronously rotate counterclockwise and thereby allow a second hair band 660* to move downward onto the first linear actuator 1240 and into the previous position of the first hair band 640*, and
   (c) causes the second linear actuator 1260 to suitably synchronously retract and thereby not interfere with the downward movement of the second hair band 660* on the first linear actuator 1240.

It should be appreciated that in one or more other embodiments either of the opposing notches 880 of the notched hair band 860 may facilitate retention of a hair band 640′ by a latch pin 1020′ or by a cog wheel 1220′.

In operation of the hair banding tool 160, a human user (not shown) grasps the hair banding tool 160 with in the user's right hand, with the user's fingers in the finger holes 520, actuates the thumb switch 500 to splay open the jaws 340, 360 of the funnel 180, positions the lock of hair 140 between the jaws 340, 360, and releases the thumb switch 500 (which causes the jaws 340, 360 to close around the lock of hair 140). Next, the user actuates the finger switch 540 (which causes the first hair band 640 to be ejected through the ejection port 980 (and, thus, out of the magazine 240). Quickly after the hair band 640 is ejected from the magazine 240, the hair band closes around the lock of hair 140. Thereafter, the user may reposition the hair banding tool 160 elsewhere along the lock of hair 140 (for banding another part of the lock 140), or the user may reposition the banding tool 160 around a different lock of hair and band the different lock of hair via like operations as those used for banding the lock 140.

While the inventions have been illustrated and described in detail in the drawings and foregoing description, the same is to be considered as illustrative and not restrictive in character, it being understood that only certain embodiments have been shown and described and that all changes and modifications that come within the spirit of the inventions are desired to be protected.

What is claimed is:

1. An apparatus for banding hair with one of a plurality of elastic bands, each of the elastic bands being configured to be expandable from a not elastically deformed, at least generally closed ring state through an elastically deformed, at least generally closed ring state to an elastically deformed, generally C-shaped, open state, each one of the elastic bands being configured to transition itself from the elastically deformed, generally C-shaped, open state to the elastically deformed, at least generally closed ring state, the apparatus comprising:
a magazine configured to hold the elastic bands and to urge at least one of the elastic bands along a first axis, the magazine defining an ejection port configured to pass the at least one of the elastic bands therethrough;
an ejection assembly arranged and configured to urge the at least one of the elastic bands through the ejection port; and
a guide arranged and configured to hold the hair in a banding orientation such that the hair extends from the guide both adjacently to the ejection port and off-center from the first axis.

2. The apparatus of claim 1, further comprising the plurality of elastic bands.

3. The apparatus of claim 2, wherein each of the elastic bands has a first end, a second end, and a body portion disposed between the first end and the second end, and wherein in the elastically deformed, at least generally closed ring state the first end generally overlaps at least some of the body portion.

4. The apparatus of claim 3, wherein in the elastically deformed, at least generally closed ring state the first end generally radially overlaps some of the body portion.

5. The apparatus of claim 3, wherein in the elastically deformed, at least generally closed ring state the first end generally axially overlaps some of the body portion.

6. The apparatus of claim 2, wherein each of the elastic bands has a first end, a second end, and a body portion disposed between the first end and the second end, and wherein in the elastically deformed, at least generally closed ring state the first end abuts the second end.

7. The apparatus of claim 3, wherein the ejection port is configured to pass the at least one of the elastic bands therethrough at least generally transversely to the first axis.

8. The apparatus of claim 7, wherein the magazine comprises a longitudinal compartment configured to receive the plurality of elastic bands, wherein the magazine comprises a curved surface extending between the longitudinal compartment and the ejection port, and wherein the ejection assembly comprises the curved surface.

9. The apparatus of claim 8, wherein the magazine is configured to coaxially space apart the plurality of elastic bands.

10. The apparatus of claim 7, wherein the magazine comprises a longitudinal compartment configured to receive the plurality of elastic bands, wherein the magazine is configured to coaxially space apart the plurality of elastic bands, and wherein the magazine comprises a cog wheel arranged and configured to control successive advancements of ones of the plurality of elastic bands along the first axis.

11. The apparatus of claim 2, wherein the guide comprises a pair of opposing jaws.

12. The apparatus of claim 11, further comprising a thumb-actuatable switch arranged and configured to selectively cause the opposing jaws to open and close.

13. The apparatus of claim 12, wherein the jaws are selectively closable to form a funnel.

14. The apparatus of claim 13, further comprising an index-finger-actuatable ejection trigger switch arranged and configured to cause the ejection assembly to urge the at least one of the elastic bands through the ejection port.

15. The apparatus of claim 1, wherein the apparatus is one-hand operable to band the hair with the at least one of the elastic bands.

16. The apparatus of claim 2, wherein the apparatus is one-hand operable to band the hair with the at least one of the elastic bands.

17. The apparatus of claim 14, wherein the apparatus is one-hand operable to band the hair with the at least one of the elastic bands.

18. A method for banding hair with one of a plurality of elastic bands, each of the elastic bands being configured to be expandable from a not elastically deformed, at least generally closed ring state through an elastically deformed, at least generally closed ring state to an elastically deformed, generally C-shaped, open state, each one of the elastic bands being configured to transition itself from the elastically deformed, generally C-shaped, open state to the elastically deformed, at least generally closed ring state, the method comprising:
concurrently holding each of the elastic bands in the elastically deformed, generally C-shaped, open state; and
extending at least one of the elastic bands around the hair when the at least one of the elastic bands is not in the elastically deformed, at least generally closed ring state,
wherein the at least one of the elastic bands transitions itself to the elastically deformed, at least generally closed ring state when the at least one of the elastic bands is extended around the hair.

19. The method of claim 18, wherein concurrently holding each of the elastic bands in the elastically deformed, generally C-shaped, open state comprises concurrently holding each of the elastic bands in the elastically deformed, generally C-shaped, open state via a magazine loaded with the elastic bands.

20. The method of claim 19, wherein extending the at least one of the elastic bands around the hair when the at least one of the elastic bands is not in the elastically deformed, at least generally closed ring state comprises urging at least one of the elastic bands through a port of the magazine.

21. The method of claim 18, further comprising:
spreading apart opposing jaws of a funnel;
extending the funnel around the hair when the jaws of the funnel are spread apart; and
closing the jaws of the funnel when the hair is positioned between the jaws of the funnel.

22. The method of claim 21, further comprising holding the hair in the funnel such that the hair extends adjacently to a port of a magazine,

23. The method of claim 22, wherein extending the at least one of the elastic bands around the hair when the at least one of the elastic bands is not in the elastically deformed, at least generally closed ring state comprises urging at least one of the elastic bands through the port of the magazine.

24. The method of claim 18, further comprising expanding each of the elastic bands from the not elastically deformed, at least generally closed ring state through the elastically deformed, at least generally closed ring state to the elastically deformed, generally C-shaped, open state.

25. The method of claim 20, further comprising expanding each of the elastic bands from the not elastically deformed, at least generally closed ring state through the elastically deformed, at least generally closed ring state to the elastically deformed, generally C-shaped, open state.

26. The method of claim 23, further comprising expanding each of the elastic bands from the not elastically deformed, at least generally closed ring state through the elastically deformed, at least generally closed ring state to the elastically deformed, generally C-shaped, open state.
